(19) United States
(12) Patent Application Publication
(10) Pub. No.: US 2013/0250350 A1
(43) Pub. Date: Sep. 26, 2013

(54) INFORMATION PROCESSING APPARATUS, NON-TRANSITORY COMPUTER READABLE MEDIUM STORING INFORMATION PROCESSING PROGRAM, AND INFORMATION PROCESSING METHOD

(71) Applicant: Kouichi ODAJIMA, Kanagawa (JP)

(72) Inventor: Kouichi ODAJIMA, Kanagawa (JP)

(73) Assignee: FUJI XEROX CO., LTD., Tokyo (JP)

(21) Appl. No.: 13/605,187

(22) Filed: Sep. 6, 2012

(30) Foreign Application Priority Data
Mar. 22, 2012 (JP) 2012-064812

(51) Int. Cl. G06F 15/00

(52) U.S. Cl. 358/1.15

(57) ABSTRACT

An information processing apparatus includes a first receiving unit that receives information about settings of a second information processing apparatus using communication from a first information processing apparatus, a first transmitting unit that transmits an instruction to perform communication from the second information processing apparatus to the information processing apparatus to the first information processing apparatus as a response to the information received by the first receiving unit, a second receiving unit that receives information from the second information processing apparatus on the basis of the instruction, and a second transmitting unit that transmits the information about the settings of the second information processing apparatus received by the first receiving unit to the second information processing apparatus when the second receiving unit receives the information from the second information processing apparatus.

### CROSS-REFERENCE TO RELATED APPLICATIONS

This application is based on and claims priority under 35 USC 119 from Japanese Patent Application No. 2012-064812 filed Mar. 22, 2012.

### BACKGROUND

### Technical Field

The present invention relates to an information processing apparatus, a non-transitory computer readable medium storing an information processing program, and an information processing method.

### SUMMARY

According to an aspect of the invention, there is provided an information processing apparatus including: a first receiving unit that receives information about settings of a second information processing apparatus using communication from a first information processing apparatus; a first transmitting unit that transmits an instruction to perform communication from the second information processing apparatus to the information processing apparatus to the first information processing apparatus as a response to the information received by the first receiving unit; a second receiving unit that receives information from the second information processing apparatus on the basis of the instruction; and a second transmitting unit that transmits the information about the settings of the second information processing apparatus received by the first receiving unit to the second information processing apparatus when the second receiving unit receives the information from the second information processing apparatus.

### BRIEF DESCRIPTION OF THE DRAWINGS

Exemplary embodiments of the present invention will be described in detail based on the following figures, wherein:

FIG. 1 is a conceptual module configuration diagram illustrating an example of a structure according to an exemplary embodiment;

FIG. 2 is a diagram illustrating an example of the structure of a system according to this exemplary embodiment;

FIG. 3 is a flowchart illustrating an example of a process according to this exemplary embodiment;

FIG. 4 is a diagram illustrating an example of the data structure of an apparatus management table;

FIG. 5 is a diagram illustrating an example of a setting screen;

FIGS. 6A and 6B are diagrams illustrating an example of the data structure of a setting management table and an example of the process according to this exemplary embodiment;

FIGS. 7A and 7B are diagrams illustrating an example of the process according to this exemplary embodiment;

FIGS. 8A and 8B are diagrams illustrating an example of the process according to this exemplary embodiment;

FIGS. 9A and 9B are diagrams illustrating an example of the data structure of the setting management table and an example of the process according to this exemplary embodiment;

FIGS. 10A to 10C are diagrams illustrating an example of the process according to this exemplary embodiment;

FIGS. 11A and 11B are diagrams illustrating an example of the process according to this exemplary embodiment;

FIG. 12 is a block diagram illustrating an example of the hardware structure of a computer for implementing this exemplary embodiment (an information processing apparatus and a setting apparatus); and

FIG. 13 is a block diagram illustrating an example of the hardware structure of a computer for implementing this exemplary embodiment (apparatus).

### DETAILED DESCRIPTION

Hereinafter, an exemplary embodiment of the invention will be described with reference to the accompanying drawings.

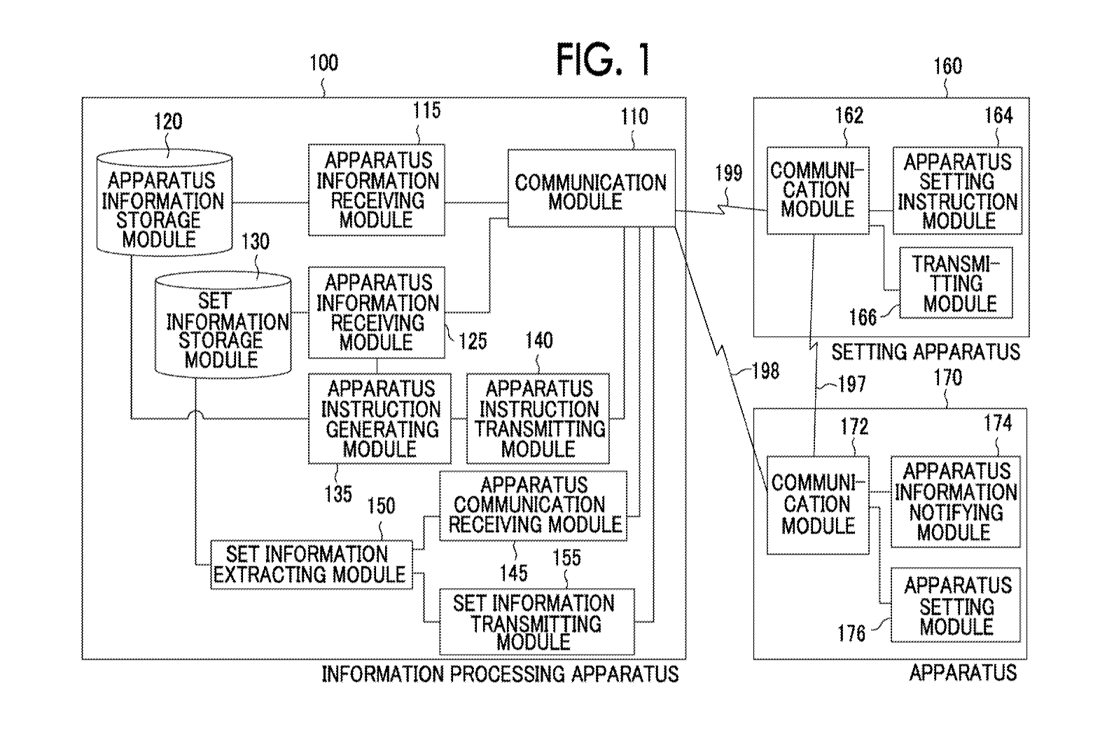

FIG. 1 is a conceptual module configuration diagram illustrating an example of a structure according to this exemplary embodiment.

The term, “module” refers generally to a component, such as logically separable software (computer program) and hardware. Therefore, a module in this exemplary embodiment indicates not only a module in a computer program but also a module in a hardware structure. Thus, this exemplary embodiment relates to a computer program (including a program which causes a computer to perform each process, a program which causes a computer to function as each unit, and a program which causes a computer to implement the functions of each unit) that causes a computer to function as modules, a system, and a method. For convenience of description, as used herein, “store,” “be stored”, or the equivalents thereof mean that a computer program is stored in a storage device or is controlled such that it is stored in a storage device when the exemplary embodiment relates to the computer program. The module may be in one-to-one correspondence with a function. When modules are mounted, one module may foe configured as one program, plural modules may be formed by one program, or one module may foe formed by plural programs. Plural modules may be implemented by one computer, or one module may foe implemented by plural computers in distributed or parallel environments. One module may include other modules. Hereinafter, the term “connection” includes physical connection and logical connection (for example, the transmission and reception of data, instructions, and the reference relationship between data). The term “predetermined” means being predetermined prior to a target process. The term “predetermined” includes not only determination before a process according to the exemplary embodiment starts but also determination according to situations and conditions at that time or situations and conditions up to that time before a target process after the process according to the exemplary embodiment starts. When there are plural “predetermined values”, the predetermined values may be different from each other or two or more values (of course, including ail values) may be equal to each other. In addition, the sentence “when A is satisfied, B is performed” means that “if it is determined, that A is satisfied, B is performed”. However, a case in which it is not necessary to determine whether A is satisfied is excluded.

The term “system” or “apparatus” includes a structure including, for example, one computer, hardware, and a device and a structure in which, for example, plural computers, hardware, and devices are connected to each other by a communication unit, such as a network (including one-to-one correspondence communication connection). In the specification, “apparatus” is synonymous with “system.” Of course, the “system” does not include anything that is merely a social “structure” (social system) that includes artificial decisions.

For each process by each module or each process when plural processes are performed in a module, target information is read from a storage device and is then processed and the process result is written to the storage device. Therefore, in some cases, the description of reading information from the storage device before the process and writing the process result to the storage device after the process is omitted. The storage device may include, for example, a hard disk, a Random Access Memory (RAM), an external storage medium, a storage device through a communication line, and a register in a Central Processing Unit (CPU).

As shown in FIG. 1, an information processing apparatus 100 according to this exemplary embodiment includes a communication module 110, an apparatus information receiving module 115, an apparatus information storage module 120, a set information receiving module 125, a set information storage module 130, an apparatus instruction generating module 135, an apparatus instruction transmitting module 140, an apparatus communication receiving module 145, a set information extracting module 150, and a set information transmitting module 155. The information processing apparatus 100 is connected to a setting apparatus 160 through a communication line 199 and is connected to an apparatus 170 through a communication line 198. In addition, the setting apparatus 160 and the apparatus 170 are connected to each other through a communication line 197.

The communication line 198 and the communication line 199 may be provided with a firewall. When the firewall is provided, the setting apparatus 160 and the apparatus 170 are provided inside the firewall and the information processing apparatus 100 is provided outside the firewall. For example, the setting apparatus 160 and the apparatus 170 are provided in a company's intranet. Therefore, the setting apparatus 160 and the apparatus 170 inside the firewall may communicate with the information processing apparatus 100 outside the firewall at any time, but the information processing apparatus 100 may not communicate with the setting apparatus 160 or the apparatus 170 at any time. When the setting apparatus 160 communicates with the information processing apparatus 100, the information processing apparatus 100 may communicate with the setting apparatus 160 as a response. When the apparatus 170 communicates with the information processing apparatus 100, the information processing apparatus 100 may communicate with the apparatus 170 as a response.

The information processing apparatus 100 receives settings set by the apparatus 170 from the setting apparatus 160 and transmits the settings to the apparatus 170.

The apparatus 170 performs information processing including linage processing and is, for example, an image processing apparatus (specifically, a copier, a facsimile machine, a scanner, a printer, or a multi-function machine (for example, an image processing apparatus with two or more functions of a scanner, a printer, a copier, and a facsimile machine)) or a Personal Computer (PC). Plural apparatuses 170 may be connected to the information processing apparatus 100.

For example, the settings set by the apparatus 170 include a process of setting a power saving mode and a process of setting an address table in the facsimile machine.

The setting apparatus 160 generates information about the settings set by the apparatus 170. For example, the setting apparatus 160 generates information about the process of setting the power saving mode and the process of setting the address table in the facsimile machine. More specifically, the setting apparatus 160 generates setting data (the time required to change to the power saving mode or the content of the address table, such as an address, a telephone number, and a facsimile number) for performing these processes. In addition, plural setting apparatuses 160 may be connected to the information processing apparatus 100.

The setting apparatus 160 includes a communication module 162, an apparatus setting instruction module 164, and a transmitting module 166.

The communication module 162 is connected to the apparatus setting instruction module 164 and the transmitting module 166. In addition, the communication module 162 is connected to the communication module 110 of the information processing apparatus 100 through the communication line 199 and is connected to the communication module 172 of the apparatus 170 through the communication line 197. The communication module 162 communicates with the information processing apparatus 100 and the apparatus 170. The communication module 162 transmits information from the apparatus setting instruction module 164 to the information processing apparatus 100, receives information from the information processing apparatus 100, and transmits the received information to the transmitting module 166. In addition, the communication module 162 transmits information from the transmitting module 166 to the apparatus 170.

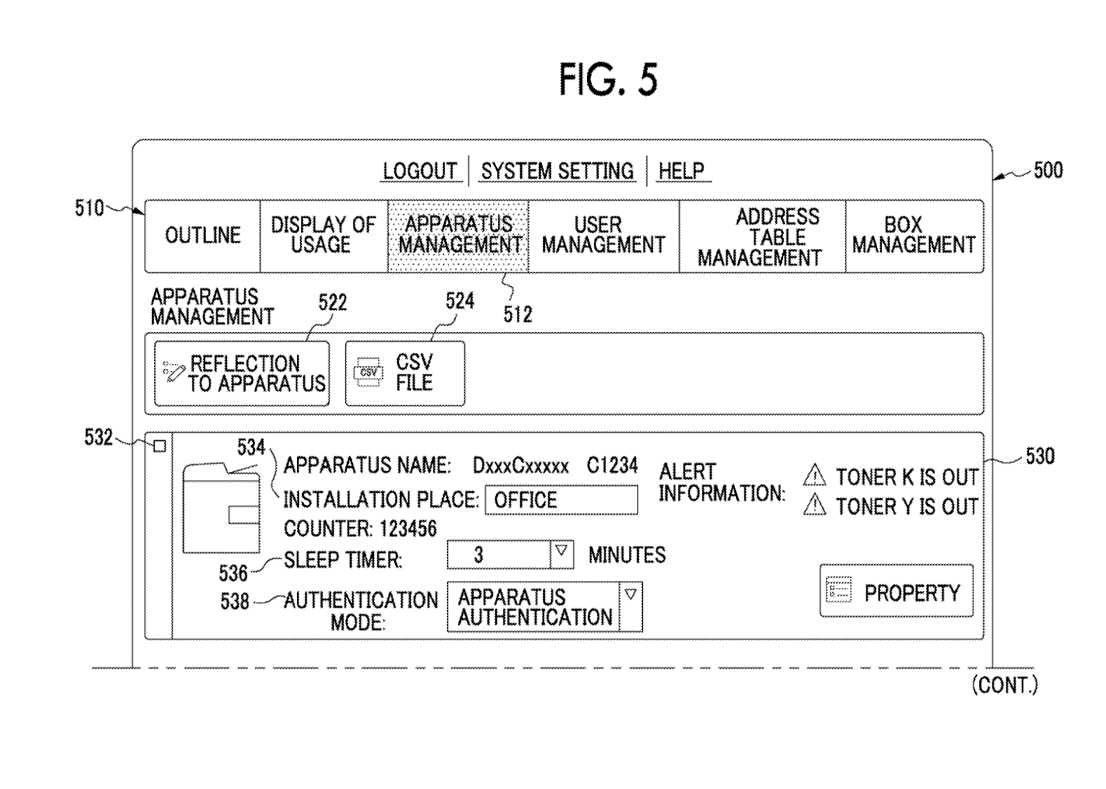

The apparatus setting instruction module 164 is connected to the communication module 162. The apparatus setting instruction module 164 generates information about the settings set for the apparatus 170. The apparatus setting instruction module 164 transmits apparatus identification information (hereinafter, referred to as an apparatus IDentification (ID)) for uniquely identifying the apparatus 170 in this exemplary embodiment or the IP address of the apparatus 170, and information about the settings of the apparatus 170 to the information processing apparatus 100. The information about the settings corresponds to the time required to charge to the power saving mode or the content of the address table, such as the address, the telephone number, and the facsimile number, as described above. The information about the settings may be generated by, for example, the operation of the operator, or predetermined information may be used as the information about the settings. When the information about the settings is generated by the operation of the operator, the generation will be described below with reference to FIG. 5.

The transmitting module 166 is connected to the communication module 162. When receiving an “instruction to perform communication from the apparatus 170 to the information processing apparatus 100” from the information processing apparatus 100, the transmitting module 166 transmits the instruction to the apparatus 170.

The apparatus 170 includes a communication module 172, an apparatus information notifying module 174, and an apparatus setting module 176.

The communication module 172 is connected to the apparatus information notifying module 174 and the apparatus setting module 176. In addition, the communication module 172 is connected to the communication module 110 of the information processing apparatus 100 through the communication line 198 and is connected to the communication module 162 of the setting apparatus 160 through the communication line 197. The communication module 172 receives information from the setting apparatus 160 and transmits the information to the apparatus setting module 176. The communication module 172 transmits information from the apparatus setting instruction module 164 to the information processing apparatus 100. In addition, the communication module 172 receives information from the information processing apparatus 100 and transmits the received information to the apparatus setting module 176. The communication module 172 transmits information from the apparatus setting module 176 to the information processing apparatus 100.

The apparatus information notifying module 174 is connected to the communication module 172. The apparatus information notifying module 174 transmits information about the apparatus 170 to the information processing apparatus 100. The information about the apparatus 170 corresponds to the apparatus ID and IP address of the apparatus 170.

The apparatus setting module 176 is connected to the communication module 172. When receiving an “instruction to perform communication from the apparatus 170 to the information processing apparatus 100” from the setting apparatus 160, the apparatus setting module 176 communicates with the information processing apparatus 100, receives information about settings from the information processing apparatus 100 as a response to the communication, and sets the information to the apparatus 170. In addition, the apparatus setting module 176 transmits a notice indicating that the settings have been completed to the information processing apparatus 100.

The communication module 110 in the information processing apparatus 100 is connected to the apparatus information receiving module 115, the set information receiving module 125, the apparatus instruction transmitting module 140, the apparatus communication receiving module 145, and the set information transmitting module 155. In addition, the communication module 110 is connected to the communication module 172 of the apparatus 170 through the communication line 198 and is connected to the communication module 162 of the setting apparatus 160 through the communication line 199. The communication module 110 communicates with the setting apparatus 160 and the apparatus 170. The communication module 110 receives information from the setting apparatus 160 and transmits the received information to the set information receiving module 125. The communication module 110 transmits information from the apparatus instruction transmitting module 140 to the setting apparatus 160. In addition, the communication module 110 receives information from the apparatus 170 and transmits the received information to the apparatus information receiving module 115 and the apparatus communication receiving module 145. The communication module 110 transmits information from the set information transmitting module 155 to the apparatus 170.

The apparatus information receiving module 115 is connected to the communication module 110 and the apparatus information storage module 120. The apparatus information receiving module 115 receives information about the apparatus 170 from the apparatus 170.

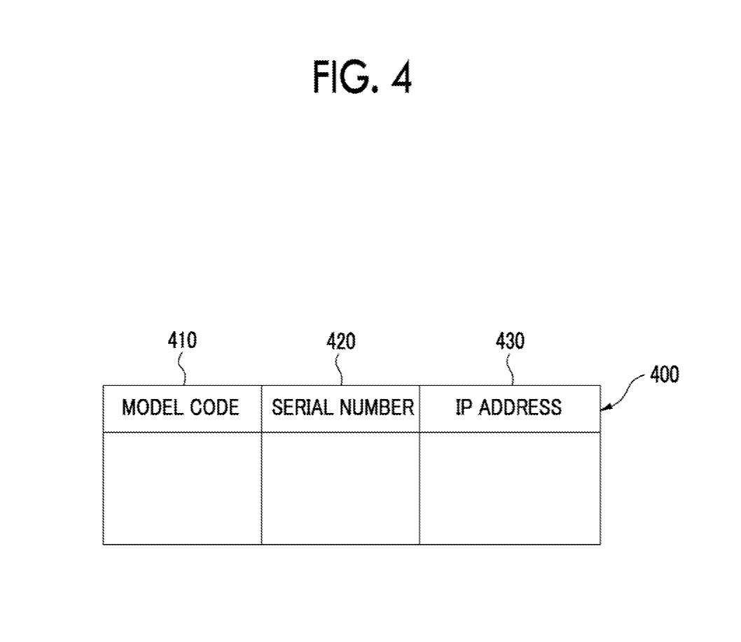

The apparatus information storage module 120 is connected to the apparatus information receiving module 115 and the apparatus instruction generating module 135. The apparatus information storage module 120 is accessed by the apparatus information receiving module 115 and the apparatus instruction generating module 135 and stores the information about the apparatus 170 which is received by the apparatus information receiving module 115. For example, the apparatus information storage module 120 stores an apparatus management table 400. FIG. 4 is a diagram illustrating an example of the data structure of the apparatus management table 400. The apparatus management table 400 includes a model code field 410, a serial number field 420, and an IP address field 430. The model code field 410 stores a model code which is information indicating the model of the apparatus 170. The serial number field 420 stores the serial number (in the model, information for uniquely identifying the apparatus 170) of the apparatus 170 in the model. Therefore, the apparatus ID is a combination of the model code and the serial number. Of course, the apparatus ID may be any information as long as it may uniquely identify the apparatus 170 in this exemplary embodiment. For example, an IP address may be used. The IP address field 430 stores an IP address for communication with the apparatus 170.

The set information receiving module 125 is connected to the communication module 110, the set information storage module 130, and the apparatus instruction generating module 135. The set information receiving module 125 receives information about the settings of the apparatus 170 using communication with the setting apparatus 160. Then, the set information receiving module 125 stores the received information about the settings of the apparatus 170 in the set information storage module 130.

In addition, the set information receiving module 125 may increase a first setting management variable stored in the set information storage module 130 whenever the information about the settings is received from the setting apparatus 160.

When receiving the information about the settings from the setting apparatus 160, the set information receiving module 125 may set the current date and time (year, month, day, second, millisecond, or combinations thereof) to the first setting management variable stored in the set information storage module 130. This is equivalent to the case in which, whenever receiving the information about the settings from the setting apparatus 160, the set information receiving module 125 increases the first setting management variable (sets the date and time to the current date and time).

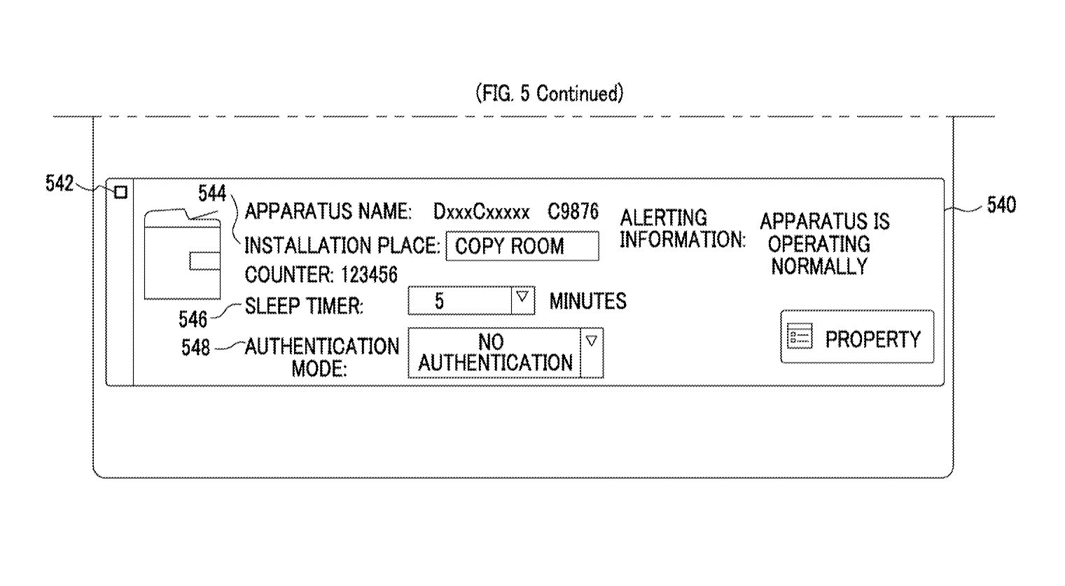

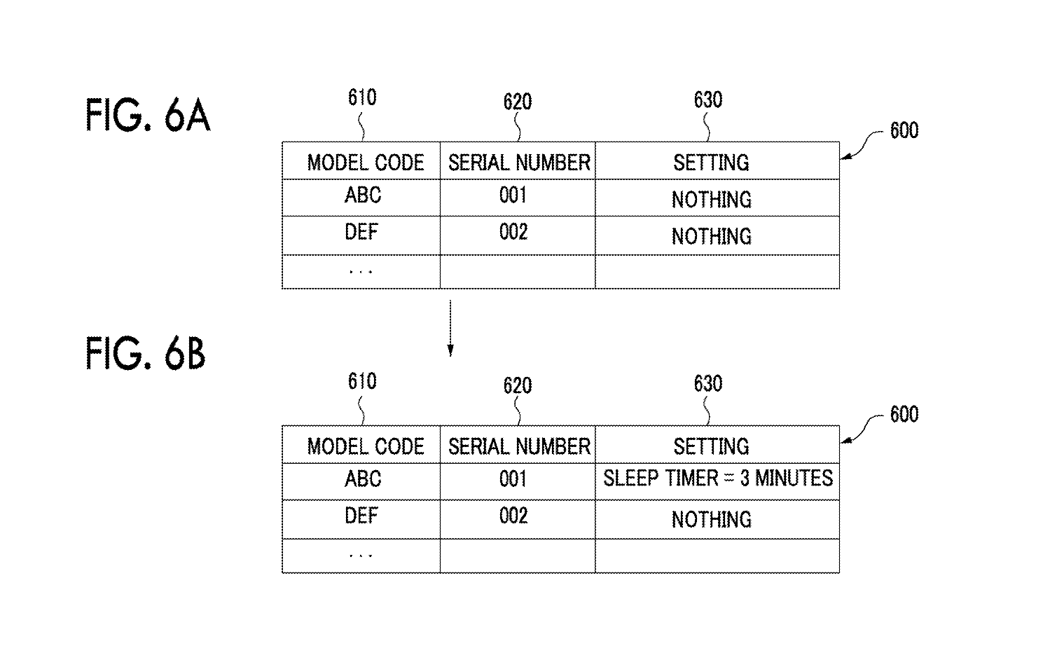

The set information storage module 130 is connected to the set information receiving module 125 and the set information extracting module 150. The set information storage module 130 is accessed by the set information receiving module 125 and the set information extracting module 150 and stores the information about the settings received from the set information receiving module 125. For example, the set information storage module 130 stores a setting management table 600. The setting management table 600 will be described below with reference to FIGS. 6A and 6B.

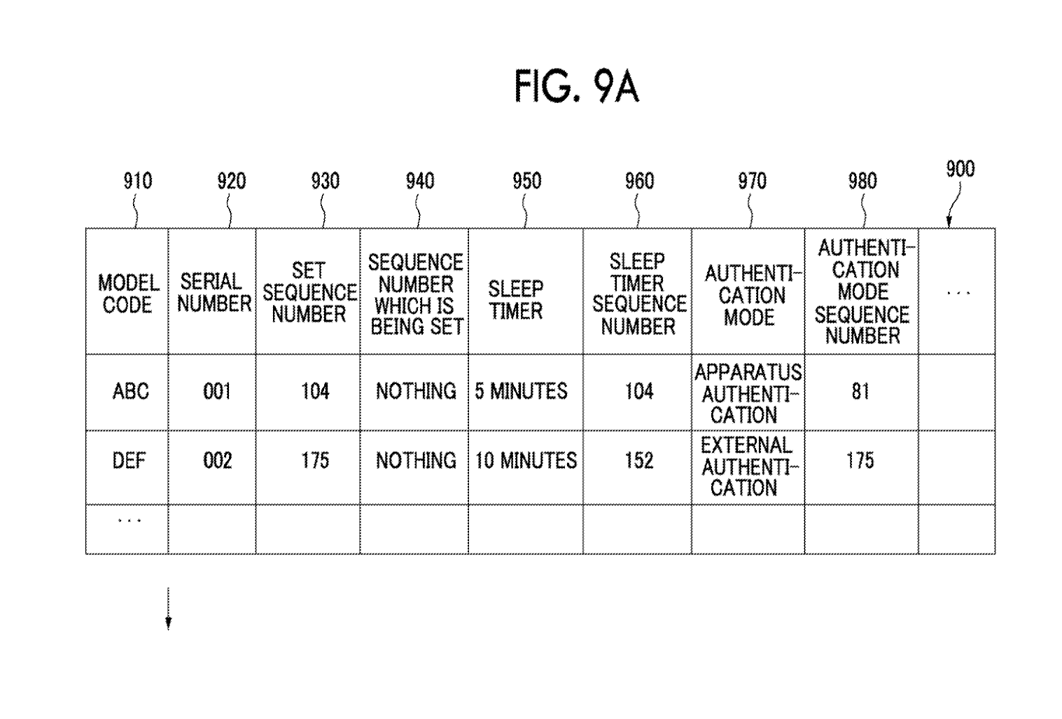

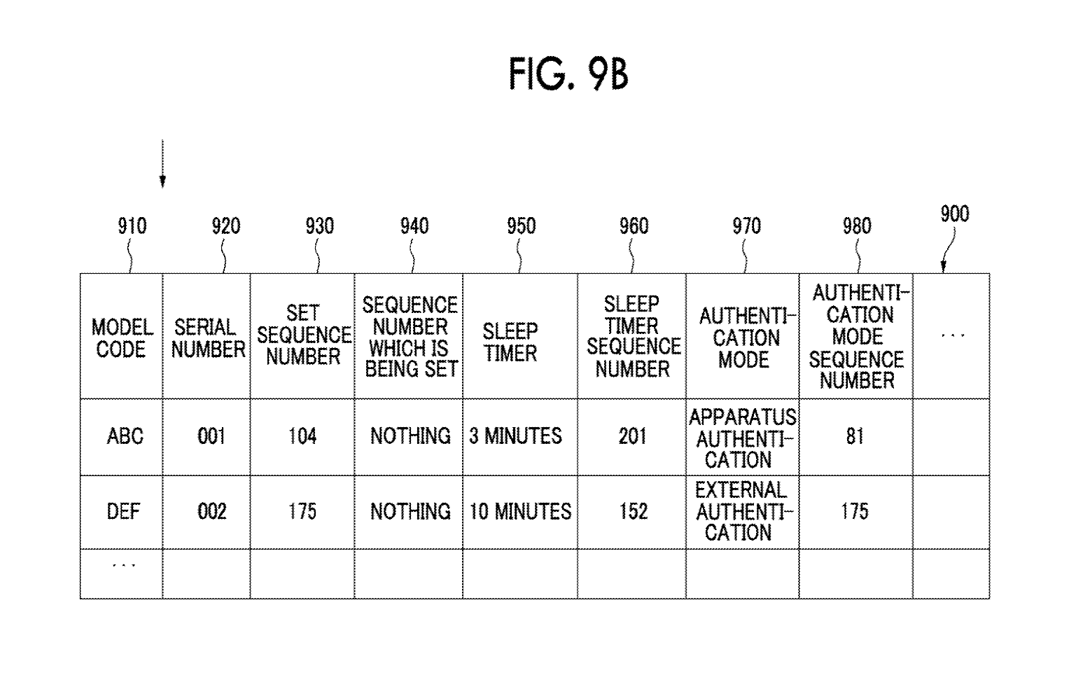

The set information storage module 130 may store the information about the settings received by the set information receiving module 125, the first setting management variable for each setting, and a second setting management variable for each apparatus 170. In addition, the set information storage module 130 may store a third setting management variable for each setting. The first setting management variable is for managing the setting items to be set and corresponds to, for example, a sequence number for each item, which will be described below. The second setting management variable is for managing the setting items that have been set and corresponds to, for example, a set sequence number, which will be described below. The third setting management variable is for managing the setting items which axe being set by the apparatus 170 and corresponds to, for example, the sequence number which is being set, which will be described below. For example, the set information storage module 130 may store a setting management table 900. The setting management table 900 will be described below with reference to FIGS. 9A and 9B.

The apparatus instruction generating module 135 is connected to the apparatus information storage module 120, the set information receiving module 125, and the apparatus instruction transmitting module 140. When the information receiving module 125 receives the information about settings, the apparatus instruction generating module 135 generates an “instruction to perform communication from the apparatus 170 to the information processing apparatus 100”. The “instruction to perform communication from the apparatus 170 to the information processing apparatus 100” is issued to perform communication from the apparatus 170 to the information processing apparatus 100 in the above-mentioned firewall environment such that the information processing apparatus 100 communicates with the apparatus 170. For example, JSONP may be used to generate the “instruction to perform communication from the apparatus 170 to the information processing apparatus 100”. For example, the JSONP is described in detail in “http://ja.wikipedia.org/wiki/JSONP”. In addition to JSONP, an “iFrame+Fragment Identifier” technique may be used. When JSONP or the “iFrame+Fragment Identifier” technique is used and the general Internet browser is operated in the setting apparatus 160, this exemplary embodiment is implemented without introducing other special applications (for example, dedicated applications for implementing this exemplary embodiment) to the setting apparatus 160.

The apparatus instruction transmitting module 140 is connected to the communication module 110 and the apparatus instruction generating module 135. The apparatus instruction transmitting module 140 transmits the “instruction to perform communication from the apparatus 170 to the information processing apparatus 100” generated by the apparatus instruction generating module 135 as a response to the information received by the set information receiving module 125 to the setting apparatus 160.

The apparatus communication receiving module 145 is connected to the communication module 110 and the set information extracting module 150. The apparatus communication receiving module 145 receives information from the apparatus 170 on the basis of the instruction transmitted from the apparatus instruction transmitting module 140. In addition, the apparatus communication receiving module 145 receives information indicating that the setting of the apparatus 170 has been completed on the basis of the information transmitted from the set information transmitting module 155. Then, when receiving the information indicating the completion of the setting, the apparatus communication receiving module 145 may set the first setting management variable corresponding to the completed setting to the second setting management variable stored in the set information storage module 130.

The set information extracting module 150 is connected to the set information storage module 130, the apparatus communication receiving module 145, and the set information transmitting module 155. The set information extracting module 150 stores the information received by the apparatus communication receiving module 145 in the set information storage module 130, or it changes the information stored in the set information storage module 130, extracts information from the set information storage module 130 in response to a request from the set information transmitting module 155, and transmits the information to the set information transmitting module 155.

The set information transmitting module 155 is connected to the communication module 110 and the set information extracting module 150. When the apparatus communication receiving module 145 receives information from the apparatus 170, the set information transmitting module 155 transmits, to the apparatus 170, the information about the setting of the apparatus 170 which is received by the set information receiving module 125.

The set information transmitting module 155 may compare the first setting management variable and the second setting management variable stored in the set information storage module 130 and extract information about setting to be transmitted to the apparatus 170 from the set information storage module 130 on the basis of the comparison result.

When the apparatus communication receiving module 145 receives information indicating the completion of the setting, the set information transmitting module 155 may set the third setting management variable corresponding to the completed setting to the second setting management variable stored in the set information storage module 130 and delete the third setting management variable.

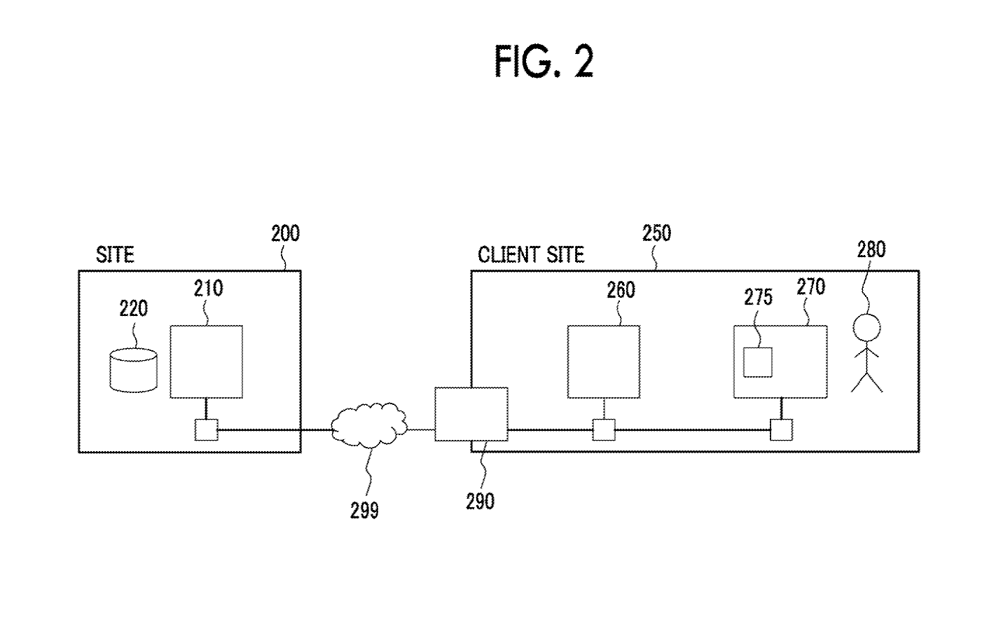

FIG. 2 is a diagram illustrating an example of the structure of the system according to this exemplary embodiment.

There are a center 210 and a database 220 in a site 200. There are an apparatus 260, a client PC 270, and an operator 280 in the client site 250. The center 210 in the site 200 is connected to the apparatus 260 and the client PC 270 in the client site 250 through the Internet 299. The site 200 communicates with the client site 250 through a firewall 290.

The centers 210 and database 220 correspond to the information processing apparatus 100 shown in FIG. 1. In particular, the database 220 corresponds to the apparatus information storage module 120 and the set information storage module 130 shown in FIG. 1, the apparatus 260 corresponds to the apparatus 170 shown in FIG. 1, and the client PC 270 corresponds to the setting apparatus 160 shown in FIG. 1. The client PC 270 includes an Internet browser 275 and the operator 280 operates the Internet browser 275 to generate information about the settings of the apparatus 260.

The database 220 stores network information about the apparatus 260 in the client site 250. The center 210 transmits control information (corresponding to the “instruction to perform communication from the apparatus 170 to the information processing apparatus 100”) for “transmitting a request to start communication with the center 210 for the apparatus 260” in response to the request from the client PC 270. Specifically, the term “transmitting a request to start communication with the center 210 for the apparatus 260” corresponds to JSONP and the “control information for “transmitting a request to start communication with the center 210 for the apparatus 260”” corresponds to JavaScript (registered trademark) included in the Web page. The center 210 uses the stored IP address of the apparatus 260 in order to create the Web page.

The apparatus 260 starts communication with the center 210 in response to the request from the client PC 270. Specifically, the apparatus 260 may receive a JSONP request. More specifically, the apparatus 260 is an HTTP server which reacts to a specific URL and starts communication with the center 210 when there is an access to the specific URL.

The client PC 270 requests the center 210 to transmit the control information for “transmitting a request to start communication with the center 210 for the apparatus 260”. Specifically, when a button on the Web page which is provided by the center 210 and is displayed by the Internet browser 275 is clicked, the Internet browser 275 transmits a request to the center 210. Then, the Internet browser 275 analyzes the control information which is transmitted from the center 210 in response to the request and executes the control information. For example, the Internet browser 275 executes JavaScript (registered trademark).

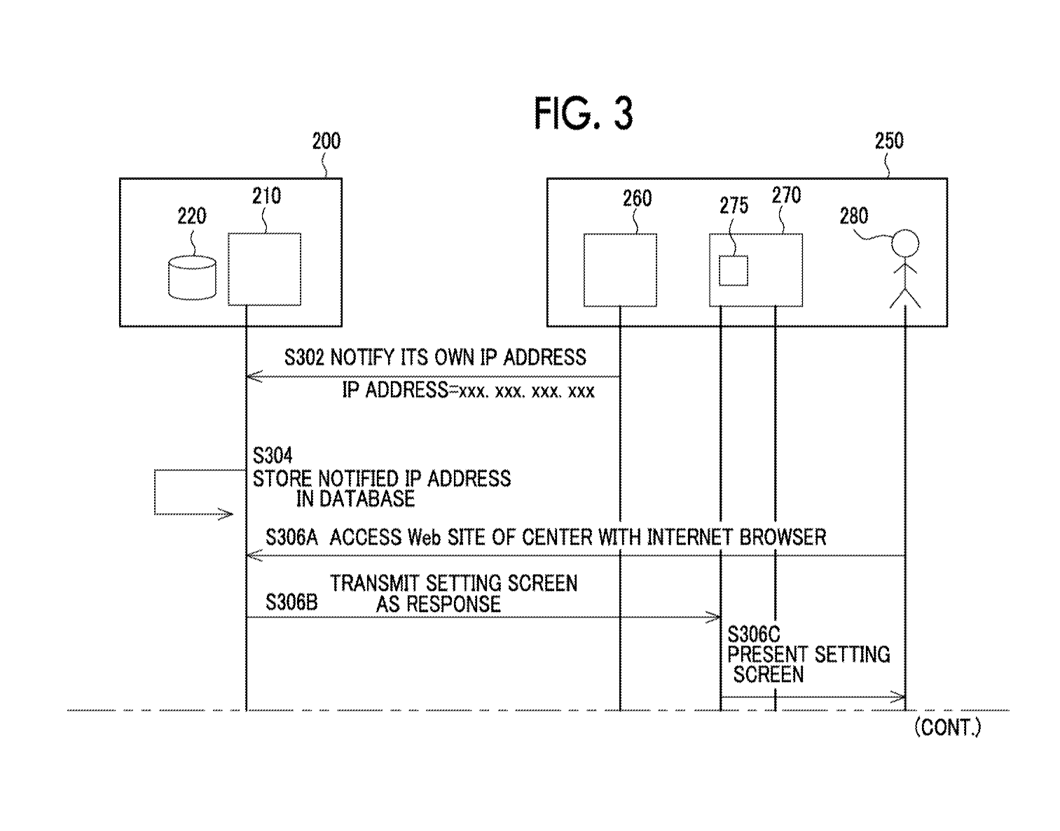

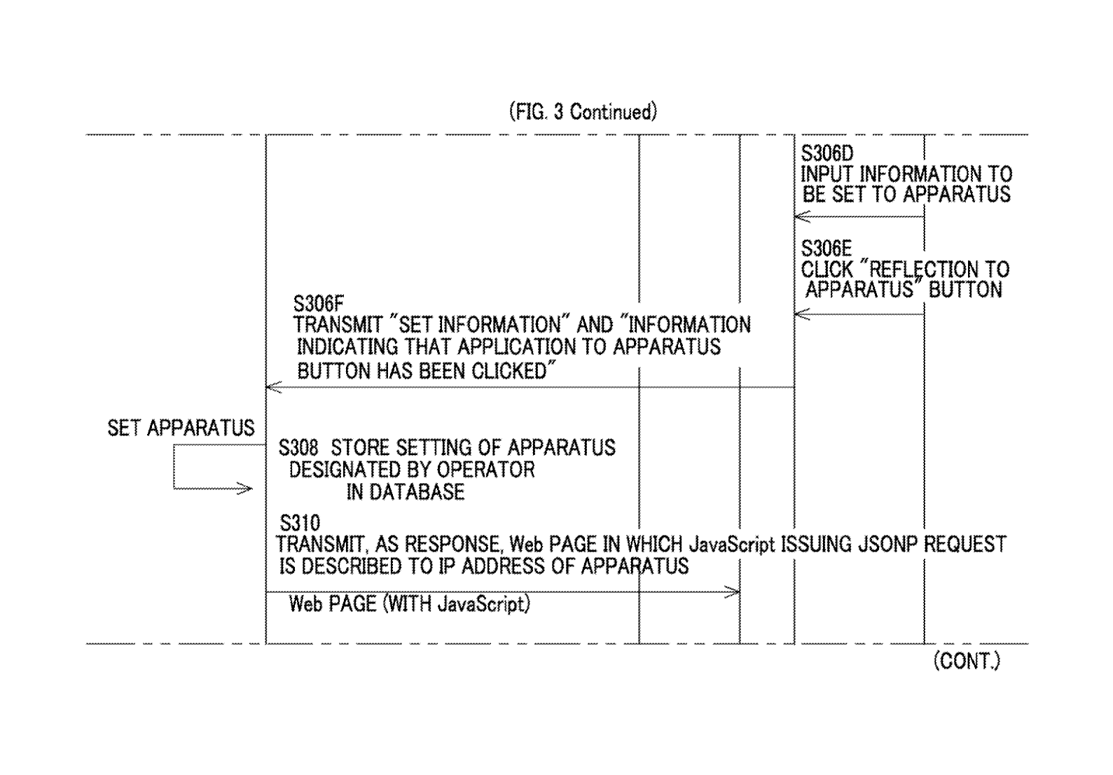

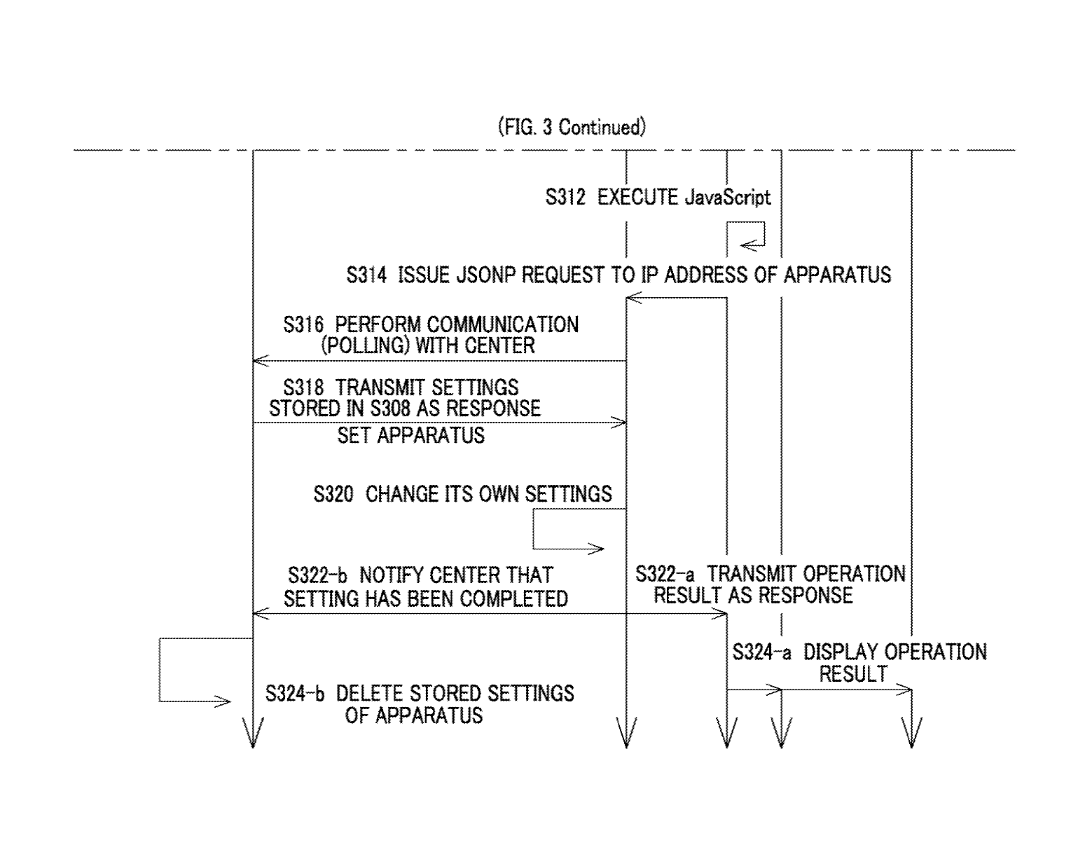

FIG. 3 is a flowchart illustrating an example of a process according to this exemplary embodiment.

In Step S302, the apparatus 260 notifies the site 200 of its own IP address.

In Step S304, the site 200 stores the notified IP address in the database 220.

Step S302 and Step S304 are performed when the apparatus 260 is installed or the IP address of the apparatus 260 is changed so as to be different from the initial IP address, or they are periodically performed. The apparatus management table 400 is generated in the apparatus information storage module 120 by this process.

In Steps S306A to S306F, the operator 280 performs an operation for “changing the settings of the apparatus 260” (in FIG. 5, an “application to apparatus” button 522) in the Web site of the center 210 for the site 200.

This operation will be described in detail.

In Step S306A, when the operator 280 performs the operation, the Internet browser 275 accesses the Web site of the center 210.

In Step S306B, the center 210 transmits the setting screen of the apparatus 260 to the Internet browser 275 as a response.

In Step S306C, the Internet browser 275 presents the setting screen to the operator 280.

A setting screen 500 shown in FIG. 5 will be described. The setting screen 500 is displayed on the display of the client PC 270 by the process of the Internet browser 275 and is presented to the operator 280. A menu area 510, the “application to apparatus” button 522, a CSV file button 524, an apparatus state information display area 530, and an apparatus state information display area 540 are displayed on the setting screen 500. In addition, for example, an apparatus name (the name of the apparatus 260), the installation place 534 (544) of the apparatus 260, a counter (the number of copies by the apparatus 260), a sleep timer 536 (546), an authentication mode 538 (548), and alert information are displayed in the apparatus state information display area 530 and the apparatus state information display area 540. FIG. 5 shows a state in which an apparatus management button 512 in the menu area 510 is selected on the setting screen 500. The installation place 534 (544), the sleep timer 536 (546), and the authentication mode 538 (548) may be rewritten by the operation of the operator 280 using, for example, a mouse, a keyboard, or a touch pane. For example, the installation place 534 (544) includes a text box and the sleep timer 536 (546) and the authentication mode 538 (548) include a combo box (a combination of a text box and an item selection list (list box)).

In Step S306D, the operator 280 uses the Internet browser 275 to input information to be set to the apparatus 260.

Specifically, when the operator 280 performs an operation to select a check box 532 (“DxxxCxxxxx C1234” is information for specifying the apparatus 260 and is a combination of a model code and an apparatus number) corresponding to, for example, an apparatus DxxxCxxxxx C1234 such that “office” in the text box of the installation place 534 is rewritten to “president's office”.

In Step S306E, the operator 280 operates the client PC 270 to click the “application to apparatus” button 522.

In Step S306F, the client PC 270 transmits, to the center 210, set information which is set in Step S306D and information indicating that “the “application to apparatus” button 522 has been clicked” in Step S306E. In the above-mentioned example, the set information indicates that “the installation place of the apparatus DxxxCxxxxx C1234 has been changed to “president's office””.

In Step S308, the site 200 stores the settings of the apparatus 260 designated by the operator 280 in the database 220. In the above-mentioned example, the information indicating that “the installation place of the apparatus DxxxCxxxxx C1234 has been changed to “president's office”” is stored.

In Step S310, the site 200 transmits a Web page to the client PC 270 as a response. JavaScript (registered trademark) for issuing a JSONP request for the IP address of the apparatus 260 (in the above-mentioned example, the IP address of the apparatus DxxxCxxxxx C1234) is described in the Web page.

In Step S312, the client PC 270 executes JavaScript (registered trademark) described in the Web page.

In Step S314, as a result of the execution of JavaScript (registered trademark), the client PC 270 issues a JSONP request for the IP address of the apparatus 260.

In Step S316, the apparatus 260 (in the above-mentioned example, the apparatus DxxxCxxxxx C1234) communicates with (polls) the center 210 in the site 200 on the basis of the received JSONP request.

In Step S318, the site 200 transmits, as a response, a setting corresponding to the apparatus 260 (in the above-mentioned example, a setting for the apparatus DxxxCxxxxx C1234, that is, a setting for changing the installation place to “president's office”) among the settings stored in Step S308 to the apparatus 260 which has communicated therewith.

In Step S320, the apparatus 260 changes its settings.

In Step S322-a, the apparatus 260 transmits the operation result to the client PC 270 as a response.

In Step S322-b, the apparatus 260 notifies the center 210 in the site 200 that the settings have been completed.

In Step S324-a, the client PC 270 displays the operation result to the operator 280.

In Step S324-b, the site 200 deletes the stored settings of the apparatus 260.

According to this aspect, a change in settings which is requested by the operator 280 through the site 200 is rapidly applied to the apparatus 260, without frequently performing the communication of the apparatus 260 with the site 200 (without communication which is not related to the request from the operator 280). That is, as described above, the firewall 290 makes it difficult for the site 200 to start communication with the apparatus 260, but makes it possible for the apparatus 260 to start communication with the site 200. Therefore, when the apparatus 260 frequently communicates with the site 200, it is possible to rapidly apply a change in the settings received by the site 200 to the apparatus 260. However, when this method is used, unnecessary communication (the communication of the apparatus 260 with the site 200 although the site 200 does not receive a change in the settings of the apparatus 260) increases and a communication load increases.

In addition, a method is considered in which the client PC 270 transmits a request to the site 200 (without waiting for a response from the site 200) and requests the apparatus 260 to start communication with the site 200. However, in this method, it is necessary to introduce a special application to the client PC 270 and the client PC 270 needs to manage, for example, the IP address of the apparatus 260.

When there are plural apparatuses 260 whose settings are to be changed (when plural apparatuses 260 are selected on the setting screen 500), plural IP addresses are transmitted to the Internet browser 275 in Step S310 and the Internet browser 275 issues the JSONP request to the plural apparatuses 260.

FIGS. 6A and 6B are diagrams illustrating an example of the data structure of the setting management table 600 and an example of the process according to this exemplary embodiment.

The setting management table 600 includes a model code field 610, a serial number field 620, and a setting field 630. The model code field 610 stores the model code and is the same as the model code field 410 of the apparatus management table 400. The serial number field 620 stores the serial number and is the same as the serial number field 420 of the apparatus management table 400. The apparatus 260 is specified by the model code field 410 and the serial number field 420. The setting field 630 stores information about the settings of the apparatus 260.

FIG. 6A shows an example of the setting management table 600 in an initial state before Step S306 is performed. FIG. 6B shows an example of the setting management table 600 in a state in which, for example, an operation for “changing the sleep timer of ABC-001 to 3 minutes” is performed in Step S306 and information about the settings of the apparatus 260 is stored in the setting field 630 of the setting management table 600 in Step S308.

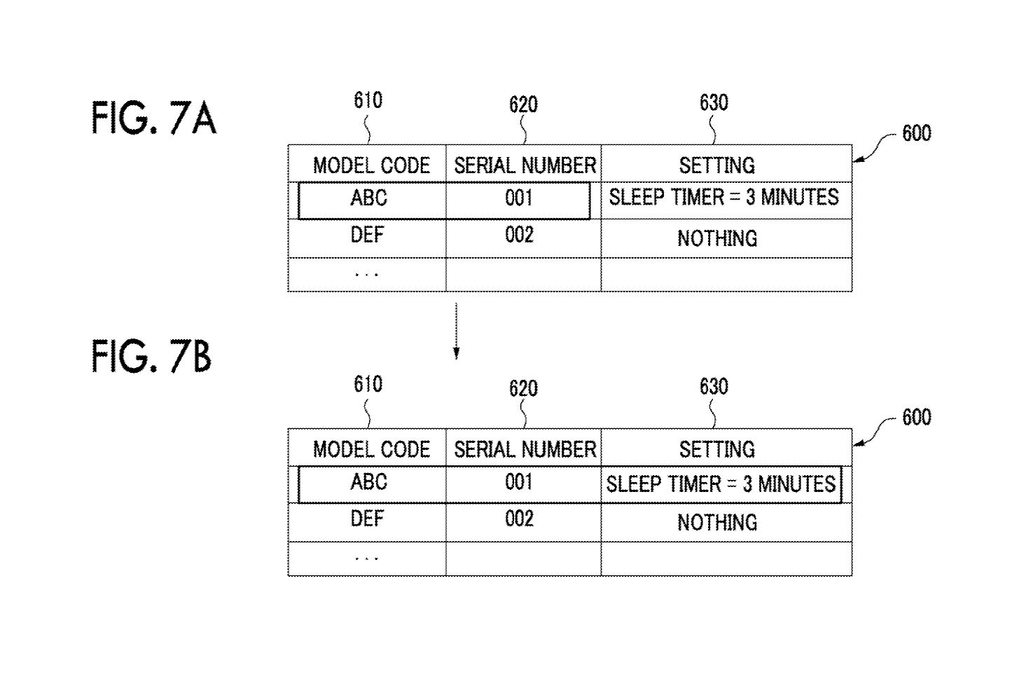

FIGS. 7A and 7B are diagrams illustrating an example of the process according to this exemplary embodiment.

FIG. 7A shows an example of the setting management table 600 in which a row of the setting management table 600 of the apparatus 260 which performs polling communication with the site 200 in Step S316 is specified. Specifically, the classification=setting inquiry, the model code=ABC, and the serial number=001 are received from the apparatus 260, which corresponds to the first row in the example shown in FIG. 7A.

The settings stored in the setting field 630 of the setting management table 600 are transmitted to the apparatus 260 by the process of Step S318. Specifically, the content (the classification=setting and the sleep timer=3 minutes) of the setting field 630 in the setting management table 600 shown in FIG. 7B is transmitted to the apparatus 260.

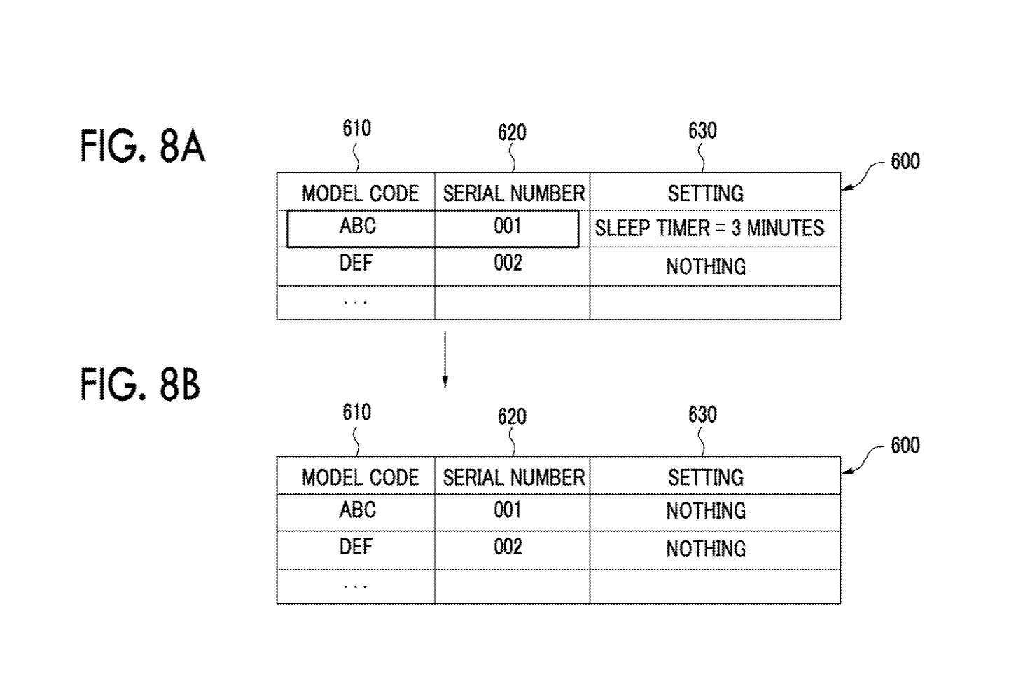

FIGS. 8A and 8B are diagrams illustrating an example of the process according to this exemplary embodiment.

FIG. 8A shows an example of the setting management table 600 in which a row of the setting management table 600 of the apparatus 260 which transmits a completion notice to the site 200 is specified by the process of Step S322-b. Specifically, the classification=setting completion, the model code=ABC, and the serial number=001 are received from the apparatus 260, which corresponds to the first row in the example shown in FIG. 8A.

Then, the settings stored in the setting field 630 of the setting management table 600 are deleted by the process of Step S324-b. Specifically, the content of the setting field 630 in the setting management table 600 shown in FIG. 8B is deleted and “nothing” is stored in the setting field 630.

The examples described, with reference to FIGS. 6A to 8B are for one setting (the setting of the sleep timer). However, in some cases, there are plural setting items as well as one setting and there is a large amount of data (for example, 10000 apparatus authenticated users and 2000 addresses). In the examples shown in FIGS. 6A to 8B, when the same settings are collectively applied to plural apparatuses 260, each apparatus 260 needs to store a large amount of data.

The following data structure may be used and the following process may be performed in order to perform a high-speed search without any overlap between data items managed by the center 210.

FIGS. 9A and 9B are diagrams illustrating an example of the data structure of a setting management table 900 and an example of the process according to this exemplary embodiment.

The setting management table 900 includes, for example, a model code field 910, a serial number field 920, a set sequence number field 930, a setting sequence number field 940, a sleep timer field 950, a sleep timer sequence number field 960, an authentication mode field 970, and an authentication mode sequence number field 980.

The model code field 910 stores the model code and is the same as the model code field 410 of the apparatus management table 400. The serial number field 920 stores the serial number and is the same as the serial number field 420 of the apparatus management table 400.

The set sequence number field 930 stores a set sequence number (second setting management variable). Next, the “sequence number” will be described. The sequence number is a number which may be updated by the center 210 and increases whenever the operator 280 performs an operation using the Internet browser 275 (for example, the sequence number may increase one by one or it may be equal to or greater than 1). In addition, the sequence number may be only one number which can be updated by the center 210. When the sequence number increases one by one, if may indicate the order in which the operator 280 performs an update process using the Internet browser 275. Each setting item has a corresponding sequence number (for example, the sleep timer sequence number field 960 corresponding to the sleep timer field 950) and the sequence number indicates “the last time when the operator 280 updates the setting item with the Internet browser 275”. Plural setting items may be managed by one sequence number. For example, the apparatus authenticated user has setting items, such as a “user ID”, a “display name”, an “IC card ID”, and a setting item indicating “whether black and white printing is available”. However, the setting items are arranged such that one sequence number is allocated to one apparatus authenticated user. In this case, when any one of the arranged settings is changed and the other arranged settings are not changed, all of the settings are transmitted to the apparatus 260.

The “set sequence number” indicates the last sequence number of the item set to each apparatus 260. Therefore, a sequence number (the sequence number of each setting item: the first setting management variable, specifically, the sleep timer sequence number field 960 corresponding to the sleep timer field 950 and the authentication mode sequence number field 980 corresponding to the authentication mode field 970) greater than the set sequence number indicates that the setting item has not been set to the apparatus 260. Therefore, when the sequence number for each setting item is greater than the set sequence number, the setting of the setting item is transmitted to the apparatus 260.

The setting sequence number field 940 stores the sequence number of the setting item which is being set by the apparatus 260.

The sleep timer field 950 stores the setting of the sleep timer. The sleep timer sequence number field 960 stores the sequence number of the setting item of the sleep timer field 950.

The authentication mode field 970 stores the setting of the authentication mode. The authentication mode sequence number field 980 stores the sequence number of the setting item of the authentication mode field 970.

FIG. 9A shows an example of the setting management table 900 in the initial state before Step S306 is performed. FIG. 9B shows an example of the setting management table 900 in a state in which, for example, an operation for “changing the sleep timer of ABC-001 to 3 minutes” is performed, in Step S306, information about the settings of the apparatus 260 is stored in the sleep timer field 950 of the setting management table 900 in Step S308, and the sequence number given when the operation is performed is stored in the sleep timer sequence number field 960.

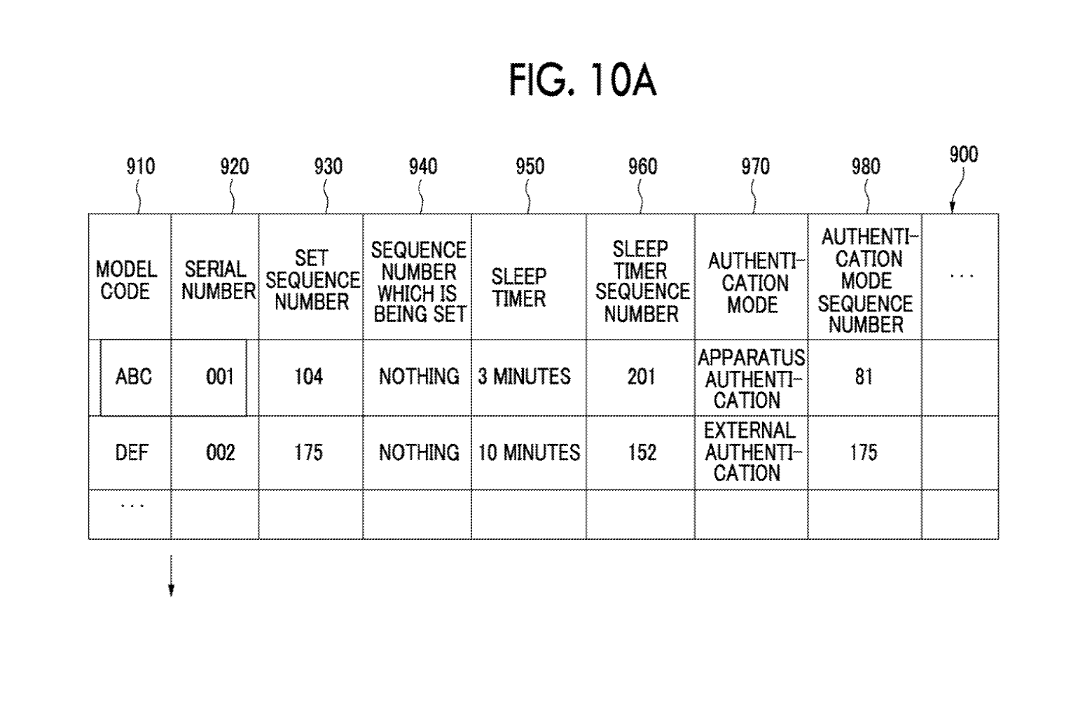

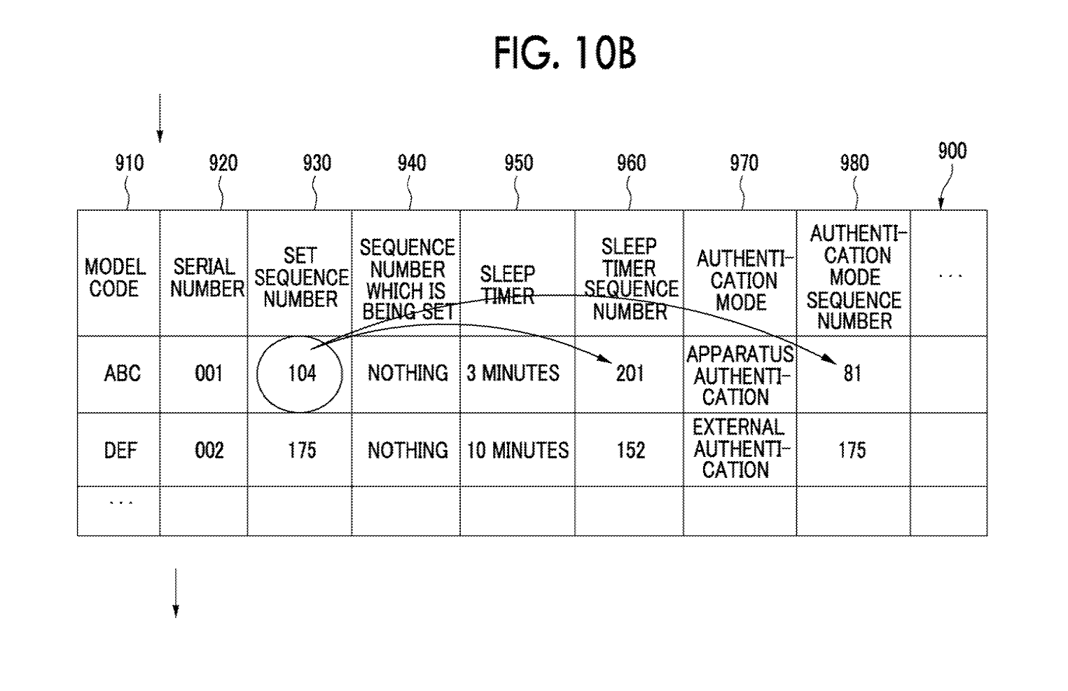

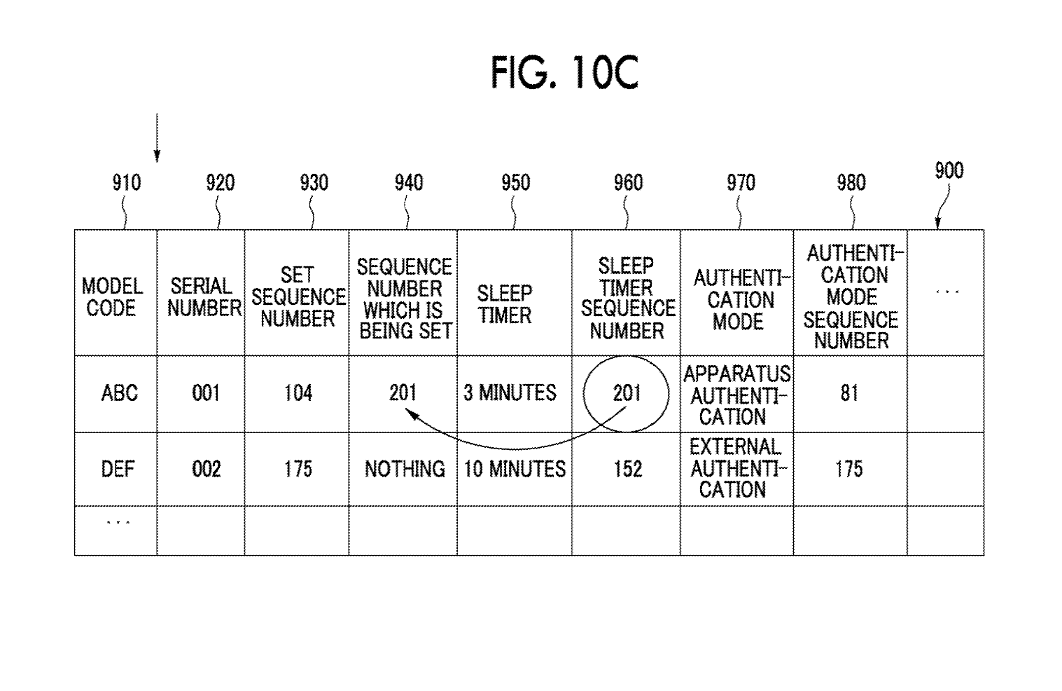

FIGS. 10A to 10C are diagrams illustrating an example of the process according to this exemplary embodiment.

FIG. 10A shows an example of the setting management table 900 in which a row of the setting management table 900 of the apparatus 260 which performs polling communication with the site 200 is specified by the process of Step S316. Specifically, the classification=setting inquiry, the model code=ABC, and the serial number=001 are received from the apparatus 260, which corresponds to the first row in the example shown in FIG. 10A.

The setting item with a sequence number greater than the “set sequence number” in the set sequence number field 930 is searched for by the process of Step S318. In the example of the setting management table 900 shown in FIG. 10B, “104” in the set sequence number field 930, “201” in the sleep timer sequence number field 960, and “81” in the authentication mode sequence number field 980 are compared. Then, the setting item (the sleep timer field 950 corresponding to the sleep timer sequence number field 960) with a sequence number greater than the “set sequence number” of the set sequence number field 930 is transmitted to the apparatus 260. Specifically, the content (the classification=setting and the sleep timer=3 minutes) of the sleep timer field 950 in the setting management table 900 shown in FIG. 10B is transmitted to the apparatus 260. Of course, when there are plural setting items with a sequence number greater than the “set sequence number”, the content of the plural setting items is transmitted to the apparatus 260.

As shown in the setting management table 900 of FIG. 10C, the largest sequence number (here, “201” in the sleep timer sequence number field 960) is stored in the setting sequence number field 940.

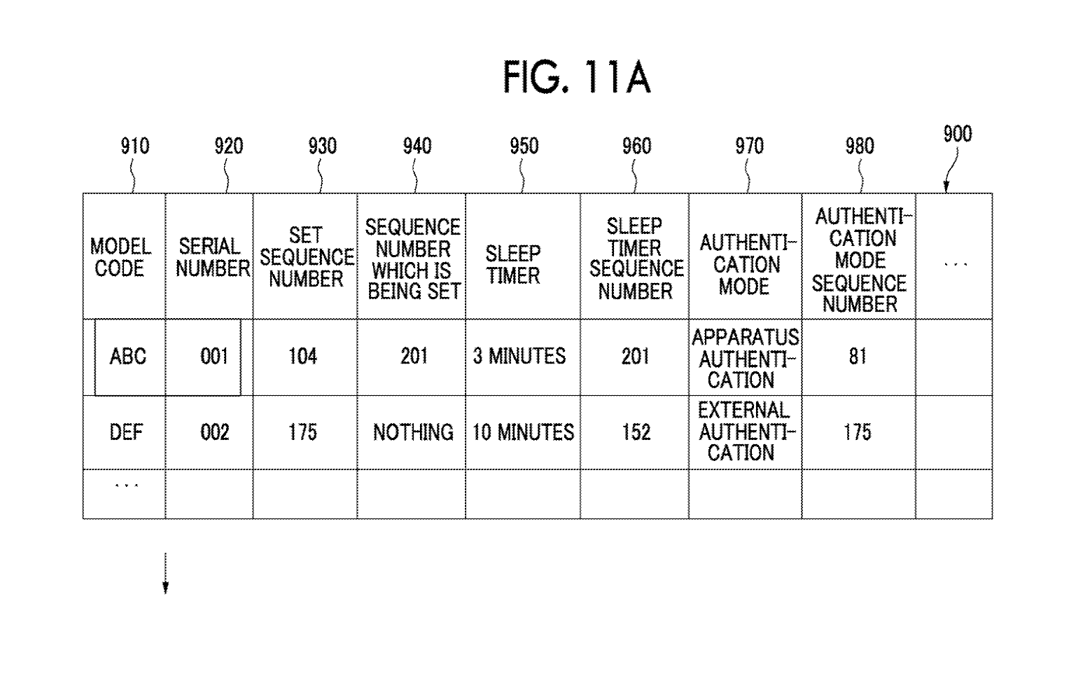

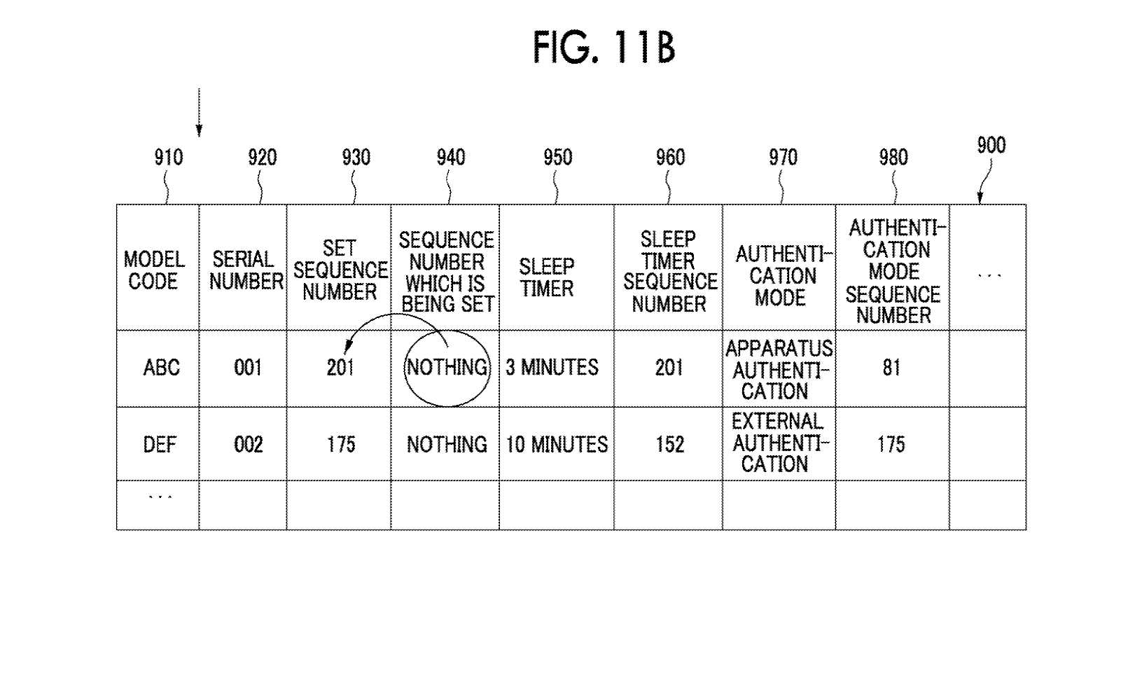

FIGS. 11A and 11B are diagrams illustrating an example of the process according to this exemplary embodiment.

FIG. 11A shows an example of the setting management table 900 in which a row of the setting management table 900 of the apparatus 260 which transmits a completion notice to the site 200 is specified by the process of Step S322-b. Specifically, the classification=setting completion, the model code=ABC, and the serial number=001 are received from the apparatus 260, which corresponds to the first row in the example shown in FIG. 11A.

The sequence number stored in the setting sequence number field 940 of the setting management table 900 is moved to the set sequence cumber field 930 by the process of Step S324-b. Specifically, the content “201” of the setting sequence number field 940 in the setting management table 900 shown in FIG. 11A is copied to the set sequence number field 930 of the setting management table 900 and the information in the setting sequence number field 940 is deleted such that “nothing” is stored in the setting sequence number field 940, as shown in FIG. 11B.

The setting sequence number field 940 is needed for the operator 280 to perform an operation even though the settings are being set by the apparatus 260. That is, when the sequence number is stored in the setting sequence number field 940, Step S306 is not performed or Step S308 waits until the process ends (“nothing” is stored in the setting sequence number field 940).

In addition, the setting sequence number field 940 is needed in order to respond to when the setting by the apparatus 260 fails. That is, when the sequence number is stored in the setting sequence number field 940 although a predetermined period of time has elapsed from Step S318, error display is performed.

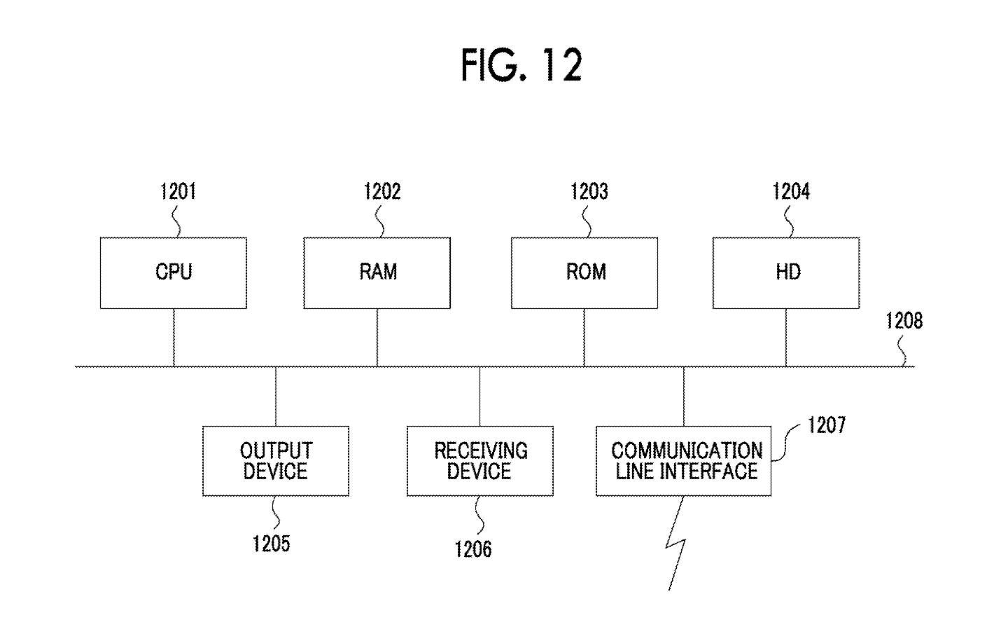

FIG. 12 shows the hardware structure of a computer that executes a program and serves as the information processing apparatus 100 and the setting apparatus 160 according to this exemplary embodiment. The computer is a general computer and is specifically a personal computer or a server. That is, for example, a CPU 1201 is used as a processing unit (arithmetic unit), and a BAM 1202, a Read Only Memory (ROM) 1203, and a Hard Disk Drive (HDD) 1204 are used as storage devices. For example, a hard disk drive may be used as the HDD 1204. The computer includes the CPU 1201 that executes a program to implement the functions of, for example, the communication module 110, the apparatus information receiving module 115, the set information receiving module 125, the apparatus instruction generating module 135, the apparatus instruction transmitting module 140, the apparatus communication receiving module 145, the set information extracting module 150, the set information transmitting module 155, the communication module 162, the apparatus setting instruction module 164, and the transmitting module 166, the RAM 1202 that stores the program or data, the ROM 1203 that stores, for example, a program for starting the computer, the HDD 1204, which is an auxiliary storage device, a receiving device 1206 that receives data on the basis of the operation of the user for a keyboard, a mouse, or a touch panel, an output device 1205, such as a CRT or a liquid crystal display, a communication line interface 1207, such as a network interface card for connection to a communication network, and a bus 1208 that connects the devices for data communication. Plural computers may be connected to each other by a network.

For a computer program in the above-described exemplary embodiment, the system with this hardware structure reads the computer program, which is software, and the above-described exemplary embodiment is implemented by cooperation between software and hardware resources.

The hardware structure shown in FIG. 12 is an illustrative example, but this exemplary embodiment is not limited to the hardware structure shown in FIG. 12. This exemplary embodiment may have any configuration as long as it may execute the modules described in this exemplary embodiment. For example, some modules may be configured as dedicated hardware components (for example, ASIC) and some modules may be provided in an external system and connected by a communication line. In addition, plural systems shown in FIG. 12 may be connected to each other by a communication line so as to cooperate with each other.

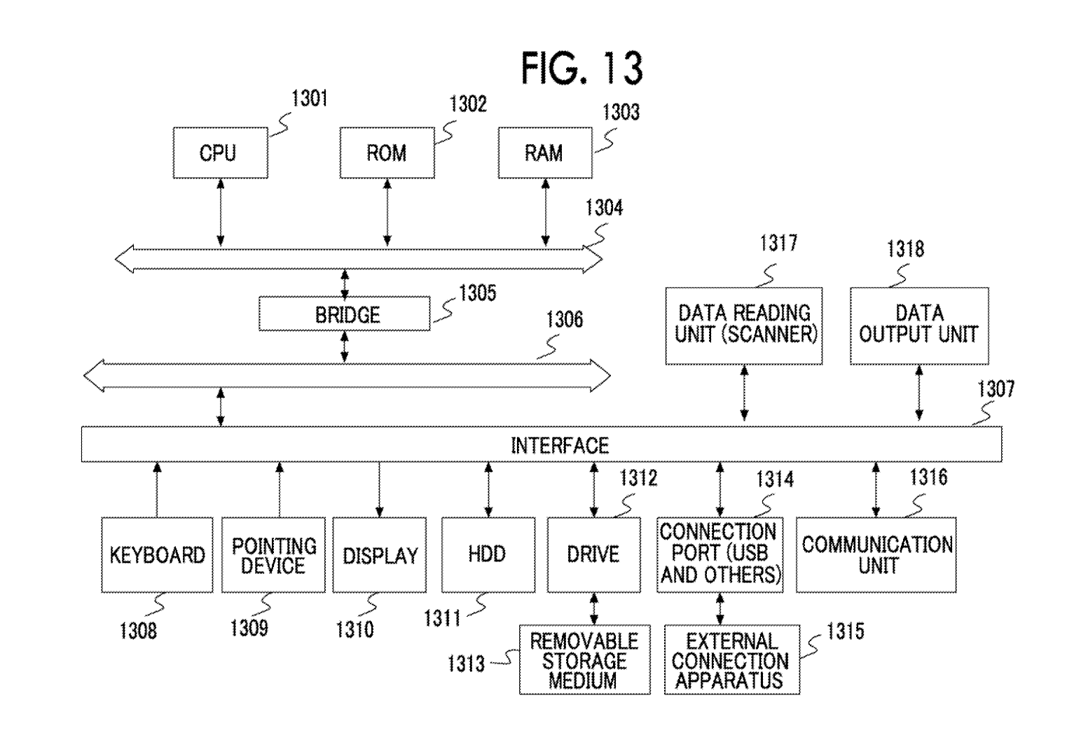

An example of the hardware structure of an image processing device of the apparatus 170 according to this exemplary embodiment will be described with reference to FIG. 13. The structure shown in FIG. 13 is formed by, for example, a person computer (PC) and FIG. 13 shows an example of the hardware structure including a data reading unit 1317, such as a scanner, and a data output unit 1318, such as a printer.

A CPU 1301 is a controller that performs a process based on a computer program in which the execution sequence of various kinds of modules according to the above-described exemplary embodiment, that is, the communication module 172, the apparatus information notifying module 174, and the apparatus setting module 176 is described.

A ROM 1302 stores, for example, programs or operation parameters used by the CPU 1301. ARM 1303 stores, for example, the program used in the execution of the CPU 1301 or parameters which are appropriately changed in the execution. These components are connected to each other by a host bus 1304 which is, for example, a CPU bus.

The host bus 1304 is connected to an external bus 1306, such as a Peripheral Component Interconnect/Interface (PCI) bus through a bridge 1305.

A keyboard 1308 and a pointing device 1309, such as a mouse, are input devices operated by the operator. A display 1310 is, for example, a liquid crystal display device or a Cathode Ray Tube (CRT) and displays various kinds of information as text or image information.

An HDD 1311 is provided with a hard disk and drives the hard disk to record or reproduce the program executed by the CPU 1301 or information. The hard disk stores, for example, set information. In addition, the hard disk stores various other computer programs, such as data processing programs.

A drive 1312 reads data or programs recorded on an inserted removable recording medium 1313, such as a magnetic disk, an optical disc, a magneto-optical disc, or a semiconductor memory, and supplies the data or program to the RAM 1303 through an interface 1307, the external bus 1306, the bridge 1305, and the host bus 1304. The removable recording medium 1313 may be used as a data recording area, similarly to the hard disk.

A connection port 1314 is for connection to the external connection apparatus 1315 and has a connection unit, such as a USB or IEEE1394. The connection port 1314 is connected to, for example, the CPU 1301 through the interface 1307, the external bus 1306, the bridge 1305, and the host bus 1304. A communication unit 1316 is connected to a communication line and performs data communication with the outside. A data reading unit 1317 is, for example, a scanner and performs a process of reading a document. The data output unit 1318 is, for example, a printer and performs a process of outputting document data.

The hardware structure of the image processing device shown in FIG. 13 is an illustrative example, but this exemplary embodiment is not limited to the structure shown in FIG. 13. This exemplary embodiment may have any configuration as long as it may execute the modules described in this exemplary embodiment. For example, some modules may be configured as dedicated hardware components (for example, Application Specific Integrated Circuit: ASIC) and some modules may be provided in an external system and connected by a communication line. In addition, plural systems shown in FIG. 13 may foe connected to each other by a communication line so as to cooperate with each other.

The above-mentioned program may foe stored in a recording medium and then provided. In addition, the above-mentioned program may be provided by a communication unit. In this case, for example, the above-mentioned program may be understood as the invention of a “computer-readable recording medium having a program recorded thereon”.

The “computer-readable recording medium having a program recorded thereon” refers to a computer-readable recording medium having a program recorded thereon which is used to, for example, install, execute, and distribute the program.

Examples of the recording medium may include digital versatile discs (DVDs), such as “DVD-R, DVD-RW, and DVD-RAM” which are the standards defined by the DVD Forum, and “DVD+R and DVD+RW” which are the standards defined by DVD+RW, compact discs (CDs), such as a read-only memory (CD-ROM), CD recordable (CD-R), and CD rewritable (CD-RW), a Blu-ray disc (registered trademark), a magneto-optical, disc (MO), a flexible disk (FD), a magnetic tape, a hard disk, a read only memory (ROM), an electrically erasable programmable read-only memory (EEPROM (registered trademark)), a flash memory, a random access memory (RAM), and a Secure Digital (SD) memory card.

The program or a part thereof may be recorded and stored in the recording medium and then distributed. In addition, the program or a part thereof may be transmitted by communication using transmission media, such as wired networks including a local area network (LAN), a metropolitan area network (MAN), a wide area network (WAN), the Internet, an intranet, and an extranet, wireless communication networks, and combinations thereof. In addition, the program or a part thereof may be transmitted using carrier waves.

The program may be a part of another program, or it may be recorded on the recording medium along with a separate program. In addition, the program may be divided and recorded on plural recording media. In addition, the program may be recorded in any form including, for example, compression and encryption as long as it may be restored.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention foe defined by the following claims and their equivalents.

What is claimed is:

1. An information processing apparatus comprising:
a first receiving unit that receives information about settings of a second information processing apparatus using communication from a first information processing apparatus;
a first transmitting unit that transmits an instruction to perform communication from the second information processing apparatus to the information processing apparatus to the first information processing apparatus as a response to the information received by the first receiving unit;
a second receiving unit that receives information from the second information processing apparatus on the basis of the instruction; and
a second transmitting unit that transmits the information about the settings of the second information processing apparatus received by the first receiving unit to the second information processing apparatus when the second receiving unit receives the information from the second information processing apparatus.

2. The information processing apparatus according to claim 1,
wherein the first information processing apparatus and the second information processing apparatus are provided inside a firewall, and
the information processing apparatus is provided outside the firewall.

3. The information processing apparatus according to claim 1, further comprising:
a third receiving unit that receives information indicating completion of setting from the second information processing apparatus on the basis of the information transmitted by the second transmitting unit; and
a memory that stores information about settings, a first setting management variable for each setting, and a second setting management variable for each second information processing apparatus,
wherein the first receiving unit increases the first setting management variable stored in the memory whenever the information about settings is received,
the second transmitting unit compares the first setting management variable and the second setting management variable stored in the memory and extracts the information about settings to be transmitted to the second information processing apparatus from the memory on the basis of the comparison result, and
when receiving the information indicating the completion of setting, the third receiving unit sets the first setting management variable corresponding to the completed setting to the second setting management variable stored in the memory.

4. The information processing apparatus according to claim 2, further comprising:
a third receiving unit that receives information indicating completion of setting from the second information processing apparatus on the basis of the information transmitted by the second transmitting unit; and
a memory that stores information about settings, a first setting management variable for each setting, and a second setting management variable for each second information processing apparatus,
wherein the first receiving unit increases the first setting management variable stored in the memory whenever the information about settings is received,
the second transmitting unit compares the first setting management variable and the second setting management variable stored in the memory and extracts the information about settings to be transmitted to the second information processing apparatus from the memory on the basis of the comparison result, and
when receiving the information indicating the completion of setting, the third receiving unit sets the first setting management variable corresponding to the completed setting to the second setting management variable stored in the memory.

5. The information processing apparatus according to claim 1, further comprising:
a third receiving unit that receives information indicating completion of setting from the second information processing apparatus on the basis of the information transmitted by the second transmitting unit; and
a memory that stores information about settings, a first setting management variable for each setting, and a second setting management variable for each second information processing apparatus,
wherein, when receiving the information about settings, the first receiving unit sets current date and time to the first setting management variable stored in the memory,
the second transmitting unit compares the first setting management variable and the second setting management variable stored in the memory and extracts the information about settings to be transmitted to the second information processing apparatus from the memory on the basis of the comparison result, and
when receiving the information indicating the completion of setting, the third receiving unit sets the first setting management variable corresponding to the completed setting to the second setting management variable stored in the memory.

6. The information processing apparatus according to claim 2, further comprising:
a third receiving unit that receives information indicating completion of setting from the second information processing apparatus on the basis of the information transmitted by the second transmitting unit; and
a memory that stores information about settings, a first setting management variable for each setting, and a second setting management variable for each second information processing apparatus,
wherein, when receiving the information about settings, the first receiving unit sets current date and time to the first setting management variable stored in the memory,
the second transmitting unit compares the first setting management variable and the second setting management variable stored in the memory and extracts the information about settings to be transmitted to the second information processing apparatus from the memory on the basis of the comparison result, and
when receiving the information indicating the completion of setting, the third receiving unit sets the first setting management variable corresponding to the completed setting to the second setting management variable stored in the memory.

7. The information processing apparatus according to claim 3,
wherein the memory stores a third setting management variable for each setting,
when transmitting the information about settings to the second information processing apparatus, the second transmitting unit sets the first setting management variable corresponding to the transmitted setting to the third setting management variable stored in the memory, and
when receiving information indicating the completion of setting, the third receiving unit sets the third setting management variable corresponding to the completed setting to the second setting management variable stored in the memory and deletes the third setting management variable.

8. The information processing apparatus according to claim 4,
wherein the memory stores a third setting management variable for each setting,
when transmitting the information about settings to the second information processing apparatus, the second transmitting unit sets the first setting management variable corresponding to the transmitted setting to the third setting management variable stored in the memory, and
when receiving information indicating the completion of setting, the third receiving unit sets the third setting management variable corresponding to the completed setting to the second setting management variable stored in the memory and deletes the third setting management variable.

9. A non-transitory computer readable medium storing an information processing program that causes a computer to function as:
a first receiving unit that receives information about settings of a second information processing apparatus using communication from a first information processing apparatus;
a first transmitting unit that transmits an instruction to perform communication from the second information processing apparatus to the information processing apparatus to the first information processing apparatus as a response to the information received by the first receiving unit;
a second receiving unit that receives information from the second information processing apparatus on the basis of the instruction; and
a second transmitting unit that transmits the information about the settings of the second information processing apparatus received by the first receiving unit to the second information processing apparatus when the second receiving unit receives the information from the second information processing apparatus.

10. An information processing method comprising:
receiving information about settings of a second information processing apparatus using communication from a first information processing apparatus;
transmitting an instruction to perform communication from the second information processing apparatus to the information processing apparatus to the first information processing apparatus as a response to the information received by the first receiving unit;
receiving information from the second information processing apparatus on the basis of the instruction; and
transmitting the information about the settings of the second information processing apparatus received by the first receiving unit to the second information processing apparatus when the second receiving unit receives the information from the second information processing apparatus.
